(19) United States
(12) Patent Application Publication
(10) Pub. No.: US 2021/0314981 A1
(43) Pub. Date: Oct. 7, 2021

(54) COMMUNICATION SYSTEM

(71) Applicant: NEC Corporation, Minato-ku, Tokyo (JP)

(72) Inventors: Caroline Quanyi LIANG, Minato-ku,k Tokyo (JP); Takahiro SASAKI, Tokyo (JP)

(73) Assignee: NEC Corporation, Minato-ku, Tokyo (JP)

(21) Appl. No.: 17/267,116

(22) PCT Filed: Jul. 8, 2019
(86) PCT No.: PCT/JP2019/026976

§ 371 Date: Feb. 9, 2021

(30) Foreign Application Priority Data
Aug. 10, 2018 (GB) 1813132.6

(51) Int. Cl. H04W 72/12

(52) U.S. Cl. CPC H04W 72/1268; H04W 72/1289

(57) ABSTRACT

A communication system is disclosed in which a base station configures an item of user equipment (UE) with pre-emptable communication resources (e.g. a mini-slot), within a set of communication resources (e.g. a slot) allocated to the UE. The UE performs uplink communication of enhanced Mobile Broadband (eMBB) data over the set of communication resources. When the UE receives an ‘UL Pre-emption Indication’, it pre-empts the pre-emptable communication resources for Ultra-Reliable and Low-Latency Communications (URLLC) communications by a different UE.

### TECHNICAL FIELD

The present invention relates to mobile communications devices and networks, particularly but not exclusively those operating according to the 3rd Generation Partnership Project (3GPP) standards or equivalents or derivatives thereof. The invention has particular although not exclusive relevance to multiplexing data traffic in the so-called ‘5G’ (or ‘Next Generation’) systems.

### BACKGROUND ART

The latest developments of the 3GPP standards are referred to as the Long Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services such as Machine Type Communications (MTC), Internet of Things (IoT) communications, vehicular communications and autonomous cars, high resolution video streaming, smart city services, and/or the like. Accordingly, 5G technologies are expected to enable network access to vertical markets and support network (RAN) sharing for offering networking services to third parties and for creating new business opportunities. 3GPP intends to support 5G by way of the so-called 3GPP Next Generation (NextGen) radio access network (RAN) and the 3GPP NextGen core (NGC) network. Various details of 5G networks and network slicing are described in, for example, the ‘NGMN 5G White Paper’ V1.0 by the Next Generation Mobile Networks (NGMN) Alliance, which document is available from https://www.ngmn.org/5g-white-paper.html.

The next-generation mobile networks must support diversified service requirements, which have been classified into three categories by the International Telecommunication Union (ITU): Enhanced Mobile Broadband (eMBB), Ultra-Reliable and Low-Latency Communications (URLLC) and Massive Machine Type Communications (mMTC). eMBB aims to provide enhanced support of conventional MBB, with focuses on services requiring large and guaranteed bandwidth such as High Definition (HD) video, Virtual Reality (VR) and Augmented Reality (AR); URLLC is a requirement for critical applications such as automated driving and factory automation, which require guaranteed access within a very short time; MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency).

### SUMMARY OF INVENTION

3GPP is currently studying physical layer enhancements for supporting various types of URLLC communications in NR networks and for supporting dynamic resource sharing between eMBB and URLLC services in uplink (UL), including eMBB and URLLC services from different UEs. However, there is no decision yet regarding how to implement such dynamic resource sharing when different UEs are involved.

In one proposed option, the eMBB UE cancels its UL transmission upon detecting an indication (from the network). In another proposed option, UL power control is used, i.e. the URLLC UE transmits over the same resource with the eMBB UE transmission with the transmission power for URLLC UL being boosted and/or transmission power for eMBB UL being reduced. In addition, it will be appreciated that multiplexing of eMBB and URLLC services (from different UEs) also needs to consider the very different latency and reliability requirements associated with the different eMBB/URLLC services.

The present invention seeks to provide methods and associated apparatus that address or at least alleviate the above issues.

Although for efficiency of understanding for those of skill in the art, the invention will be described in detail in the context of a 3GPP system (5G networks), the principles of the invention can be applied to other systems in which slice scheduling is performed.

In one example aspect, the present invention provides a method performed by user equipment (UE), the method comprising: receiving information identifying at least one communication resource, within a set of communication resources allocated to the UE, wherein the at least one communication resource is pre-emptable; receiving control data indicating that at least a part of said at least one communication resource is to be pre-empted for Ultra-Reliable and Low-Latency Communications (URLLC) communications; and pre-empting the indicated at least one communication resource based on the received control data.

In another example aspect, the present invention provides a method performed by a network apparatus, the method comprising: transmitting, to a user equipment (UE), information identifying at least one communication resource, within a set of communication resources allocated to the UE, wherein the at least one communication resource is pre-emptable; and transmitting, to the UE, control data indicating that said at least one communication resource is to be pre-empted for Ultra-Reliable and Low-Latency Communications (URLLC) communications.

In another example aspect, the present invention provides a method performed by a network apparatus, the method comprising: obtaining, from neighbouring network apparatus, information identifying a configuration for Ultra-Reliable and Low-Latency Communications (URLLC) communications in a cell of the neighbouring network apparatus; and determining an allocation of communication resources for URLLC communications in a cell of the network apparatus based on the received information.

Also disclosed is a method performed by user equipment (UE), the method comprising: transmitting, to a network apparatus serving the UE, a request for transmitting Ultra-Reliable and Low-Latency Communications (URLLC) data; receiving an allocation of at least one communication resource, within a set of communication resources allocated to a different UE; and transmitting at least a part of the URLLC data using the allocation of at least one communication resource, while the at least one communication resource is being pre-empted by the different UE.

Example aspects of the invention extend to corresponding systems, apparatus, and computer program products such as computer readable storage media having instructions stored thereon which are operable to program a programmable processor to carry out a method as described in the example aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the invention will now be described, by way of example, with reference to the accompanying drawings in which:

FIG. 1 illustrates schematically a mobile (cellular or wireless) telecommunication system to which example embodiments of the invention may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1; and

FIG. 5 illustrates schematically two exemplary procedures in accordance with example embodiments of the present invention.

FIG. 6 illustrates schematically two exemplary procedures in accordance with example embodiments of the present invention.

### DESCRIPTION OF EMBODIMENTS

Overview

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

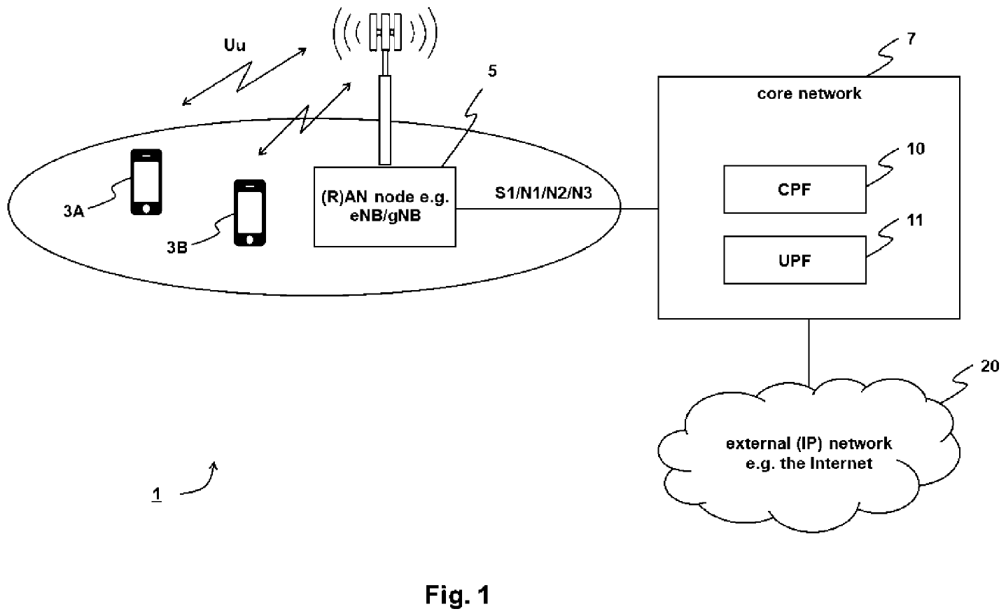

FIG. 1 illustrates schematically a mobile (cellular or wireless) telecommunication system 1 to which example embodiments of the invention may be applied.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst two mobile devices 3A and 3B and one base station 5 are shown in FIG. 1 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA/4G protocols may be referred to as an ‘eNB’ and a base station 5 that supports NextGeneration/5G protocols may be referred to as a ‘gNBs’. It will be appreciated that some base stations 5 may be configured to support both 4G and 5G protocols, and/or any other 3GPP or non-3GPP communication protocols.

The mobile device 3 and its serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5 is also connected to the core network nodes via an appropriate interface (such as the so-called ‘S1’, ‘N1’, ‘N2’, ‘N3’ interface, and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities. In this example, the core network includes at least one control plane function (CPF) 10 and at least one user plane function (UPF) 11. It will be appreciated that the core network 7 may also include one or more of the following: an Access and Mobility Function (AMF), a Session Management Function (SMF), a Policy Control Function (PCF), an Application Function (AF), an Authentication Server Function (AUSF), a Unified Data Management (UDM) entity, amongst others. The core network 7 is also coupled (via the UPF 11) to a Data Network (DN) 20, such as the Internet or a similar Internet Protocol (IP) based network (denoted ‘external network’ in FIG. 1).

In this network, mobile devices 3 may communicate uplink data using dynamically allocated communication resources (based on an associated downlink control data (DCI)) or using so-called ‘grant-free’ communication resources (also referred to as ‘configured grant’).

There are two types of grant free transmissions: configured grant Type 1 where an uplink grant is provided by Radio Resource Control (RRC) signalling, and stored as configured uplink grant; and configured grant Type 2 where an uplink grant is provided by the Physical Downlink Control Channel (PDCCH), and stored or cleared as configured uplink grant based on L1 signalling indicating configured grant activation or deactivation.

It will be appreciated that in order to meet the URLLC latency requirement, the resources for grant-free transmission need to be pre-assigned to the URLLC UE(s) (the mobile device(s) 3 involved in an URLLC service) and should be dense enough to guarantee the associated latency whenever an URLLC packet arrives.

It will be appreciated that each mobile device 3 may support one or more services which may fall into one of the categories defined above (URLLC/eMBB/mMTC). Each service will typically have associated requirements (e.g. latency/data rate/packet loss requirements, etc.), which may be different for different services.

In this example, the first mobile device 3A is involved in an eMBB service and the second mobile device 3B is involved in a URLLC service (although each mobile device may be involved in other services as well, if appropriate). Accordingly, the first mobile device 3A may be referred to as an ‘eMBB UE’ and the second mobile device 3B may be referred to as an ‘URLLC UE’. Data packets for the eMBB service may be transmitted using dynamic scheduling and/or using pre-allocated communication resources (e.g. semi-persistent scheduling/configured grant).

In this system, the first mobile device 3A (which is transmitting eMBB data) is pre-configured with a set of pre-emptable resources on one or two 4-symbol mini-slots (in every slot). In this example, the set of pre-emptable resources comprises four symbols per mini-slot (although in other examples a different number of pre-emptable resources may be used, e.g. at least one pre-emptable resource).

In a first scenario, the base station 5 (access network node) is configured to transmit (e.g. via UE specific scheduling DCI) an appropriate pre-emption indication to the mobile device 3A transmitting eMBB data in order to allow multiplexing of URLLC data by the other mobile device 3B over communication resources previously allocated to the first mobile device 3A (eMBB UE). The indication may be for example an ‘UL URLLC Pre-emption Indication’ or similar.

Upon receiving the indication from the base station 5, the first mobile device 3A (eMBB UE) suspends its transmission on the pre-emptable resources for which the indication has been received (‘duration 1’, ‘duration 2’, or both, at least in the current slot).

Beneficially, the mobile device 3A is configured to rate-match its uplink transmissions around the resources pre-empted for the other mobile device 3B (URLLC UE). It will be appreciated that since eMBB transmission by the first mobile device 3A will continue (using any non-pre-empted communication resources), and since the ratio of URLLC resources is relatively small (e.g. only one resource block or a few resource blocks) compared to the wideband transmission of eMBB, parameters (e.g. coding rate and MCS/TBS) associated with the eMBB transmissions do not need to change (unless the base station 5 determines that a reconfiguration of the eMBB communication may be beneficial in view of the pre-emption for the other UE).

Beneficially, since the payload size for UL Pre-emption Indication may be kept small, an indication of one or two bits may be used for activating pre-emption of the pre-configured pre-emptable resources.

In another scenario, the base station 5 is configured to transmit (e.g. via UE specific scheduling DCI) an appropriate pre-emption indication to the mobile device 3A, wherein the indication includes information identifying one or more of the pre-configured pre-emptable resources and (optionally) information identifying a duration (e.g. defined in milliseconds/number of slots) for the required pre-emption.

In a further scenario, neighbouring base stations 5 may be configured to exchange information with each other regarding their respective pre-emptable resources being configured for mobile devices 3 served by them so that the base stations 5 are able to reduce interference caused by UEs transmitting in other cells (coincidentally with resources to be pre-empted). Such information (including an indication of an on-going interference affecting URLLC transmissions) may be exchanged between the base stations 5 using the X2 (or Xn) interface.

User Equipment (UE)

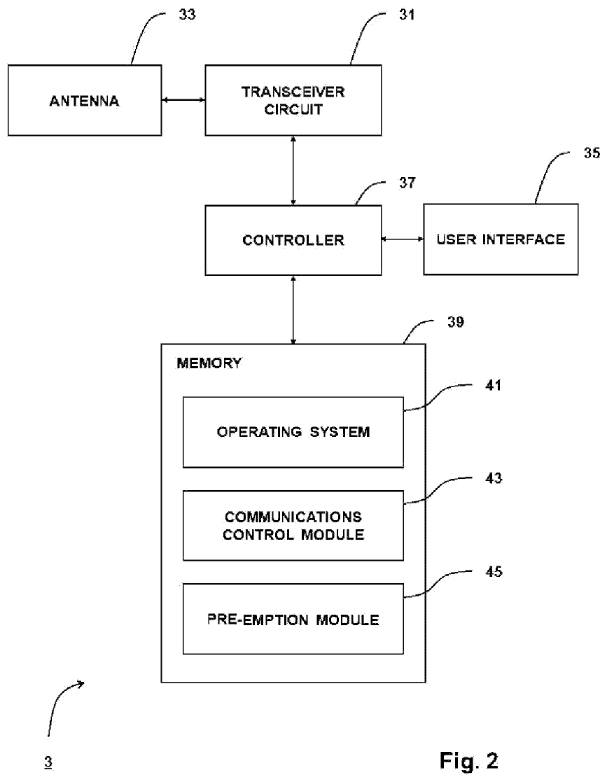

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a pre-emption module 45.

The communications control module 43 is responsible for handling (generating/sending/receiving) signalling messages and uplink/downlink data packets between the UE 3 and other nodes, including (R)AN nodes 5 and core network nodes. The signalling may comprise signalling related to the above described DRB mapping.

The pre-emption module 45 is responsible for performing the above described pre-emption indication procedure (e.g. receive/detect an appropriate pre-emption indication from the network and/or control uplink transmissions (e.g. URLLC/eMBB) by the mobile device 3 using the communication resources associated with the pre-emption indication).

Access Network Node (Base Station)

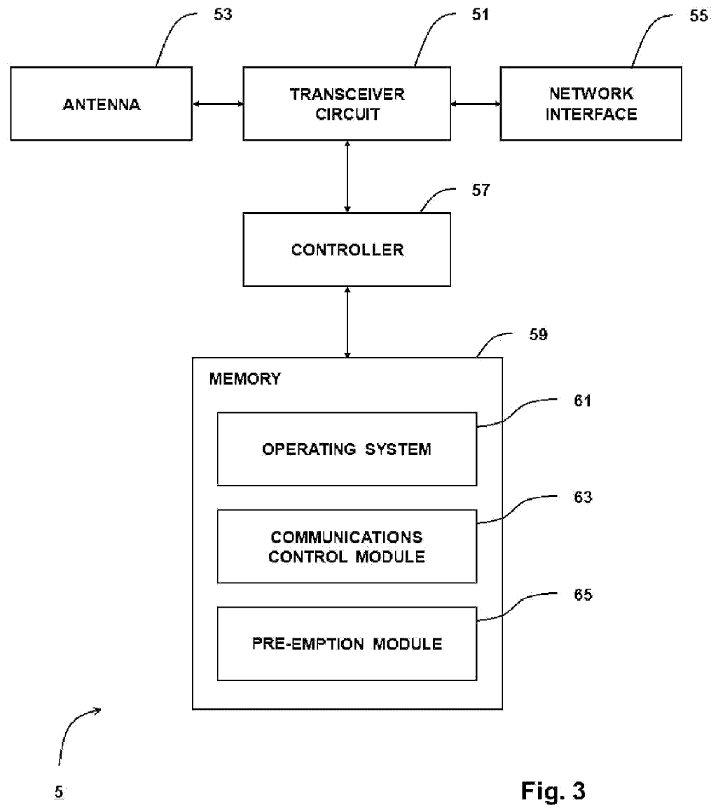

FIG. 3 is a block diagram illustrating the main components of the base station 5 (or a similar access network node) shown in FIG. 1. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and a pre-emption module 65.

The communications control module 63 is responsible for handling (generating/sending/receiving) signalling between the base station 5 and other nodes, such as the UE 3 and the core network nodes.

The pre-emption module 65 is responsible for performing the above described pre-emption indication procedure (e.g. provide/transmit an appropriate pre-emption indication to the appropriate mobile device(s) 3 in order to control uplink transmissions by the mobile device(s) 3 in accordance with the pre-emption indication).

Core Network Function

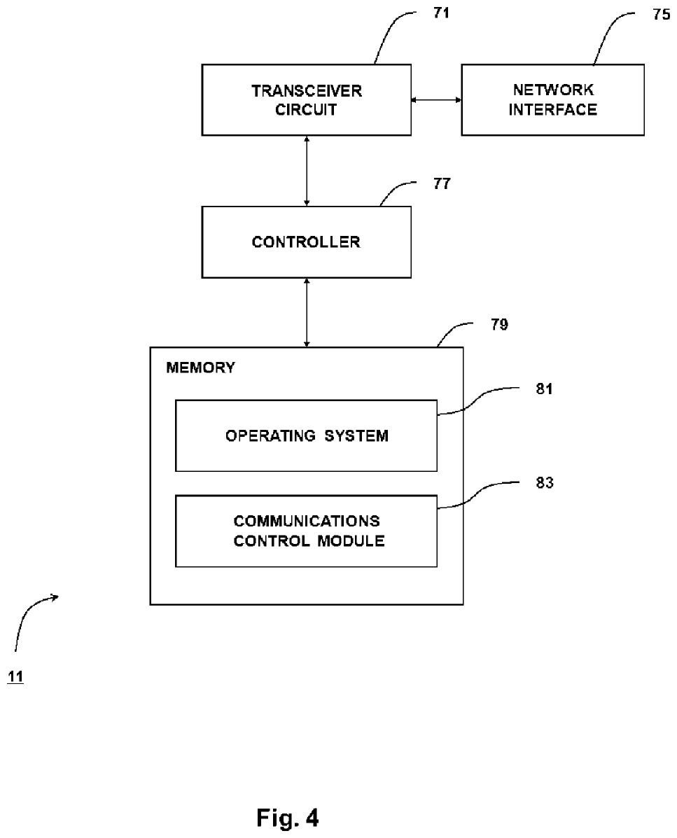

FIG. 4 is a block diagram illustrating the main components of a generic core network function, such as the UPF 11 or the AMF 12 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and a QoS module 85.

The communications control module 83 is responsible for handling (generating/sending/receiving) signaling between the core network function and other nodes, such as the UE 3, the base station 5, and other core network nodes. The signalling may comprise signalling related to the above described DRB mapping.

### DETAILED DESCRIPTION

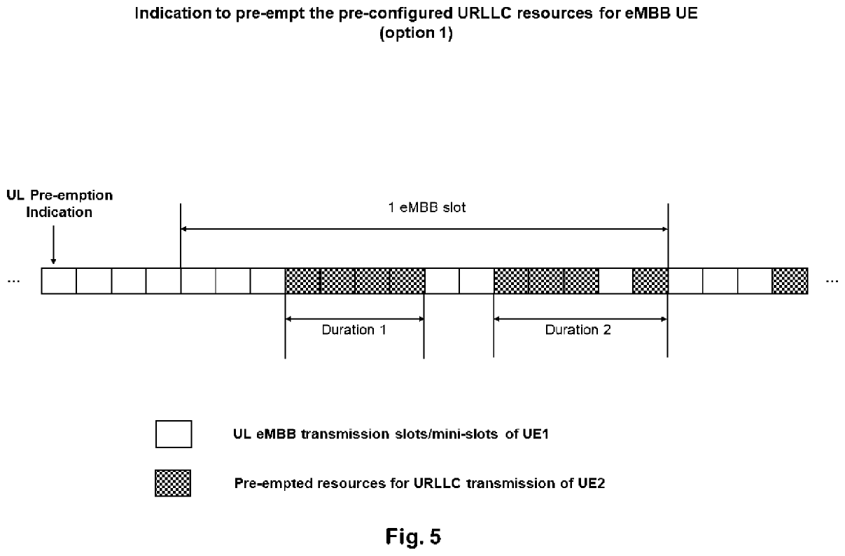

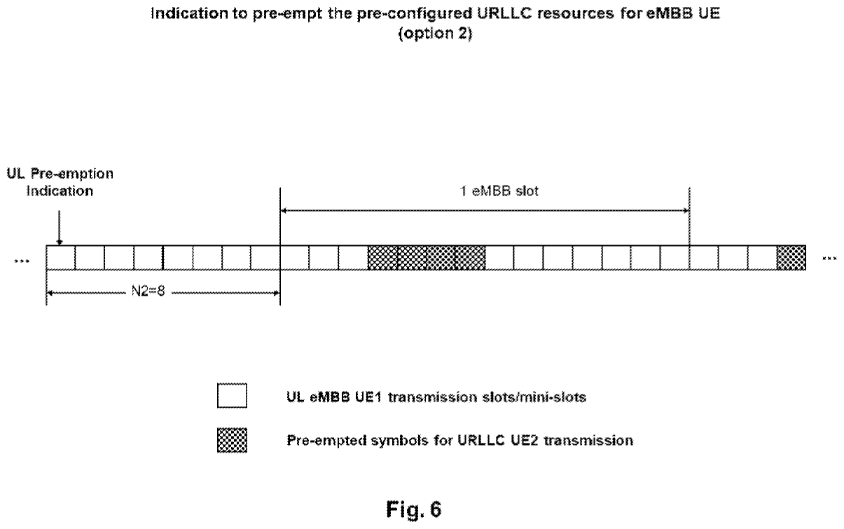

A more detailed description of some exemplary embodiments is provided below with reference to FIGS. 5 and 6.

UL Pre-Emption Indication (First Example Embodiment)

It will be appreciated that URLLC will typically have higher transmission priority (than e.g. eMBB) due to the 1 ms latency and very high reliability requirement for URLLC traffic (as per the current design goal by 3GPP). The inventors realised that multiplexing URLLC traffic with eMBB traffic (by different UEs) can provide better spectrum resource utilisation and capacity gain, for both sporadic and periodic URLLC traffic.

FIG. 5 illustrates an exemplary way in which pre-emption may be realised for multiplexing URLLC and eMBB data from different UEs.

For grant-based URLLC, the mobile device 3 (e.g. UE 3B in FIG. 1) sends a scheduling request for URLLC transmission to the base station 5 (not shown). If its URLLC service's required resources are occupied by eMBB transmissions by another mobile device 3, then the base station 5 sends (using its pre-emption module 65) an appropriate UL Pre-emption Indication to the interfering UE(s) (in this example, UE 3A). The term ‘interfering UE’ as used herein refers to a UE for which the next suitable pre-emptable resources have been allocated by the base station 5 (prior to receiving the scheduling request for URLLC transmission). The eMBB UE 3A (using its pre-emption module 45) may be configured to either cancel the eMBB transmission (in the current slot), or to modify the original grant so that it can puncture or rate-match around the resources assigned to the URLLC UE 3B.

It will be appreciated that one or two bits may be sufficient for the purpose of a pre-emption indication (to activate pre-emption of pre-configured pre-emptable resources at the eMBB UE 3A). Moreover, since URLLC requires high reliability (higher than eMBB), the above described pre-emption indication for the eMBB UE 3A may have the same (or at least similar) reliability level as URLLC communications. However, in other examples, a precise resource assignment of URLLC UE(s) 3B may be sent to the eMBB UEs 3A (with the UL Pre-emption Indication), resulting in relatively higher control signalling overhead than having a pre-emption indication of one or two bits. However, the provision of a precise resource assignment may have an effect on the attainable reliability of such UL grant modification indication.

Either a group-common or a UE specific downlink (DL) control message may be used for UL Pre-emption Indication. In order to improve the reliability of UL Pre-emption Indication, the pre-emptable resources of the eMBB UE 3A may be pre-configured (e.g. via higher layers/RRC), and then activated by a one-bit (or a two-bit) indication. This beneficially reduces/minimises the DCI payload size for transmission of the indication.

Upon receiving the UL Pre-emption Indication, the eMBB UE 3A is beneficially configured to mute its transmission only on the pre-emptable resource(s) for which the indication was received. This beneficially allows some urgent and dynamically configured type of uplink control information (UCI) (e.g. HARQ ACK/NACK) to be transmitted by the eMBB UE 3A without prolonged delay using non-pre-empted resources (even at the same time instance as the pre-empted resources if using a frequency location outside the frequency of the pre-empted resources).

The base station 5 may be configured to send (using its pre-emption module 65) information on pre-emptable resources (e.g. the time-frequency allocation, offset, periodicity in mini-slot/symbols) to the eMBB UE 3A, for example, semi-statically via RRC signalling and/or multiplexed with an UL grant for the eMBB PUSCH (Physical Uplink Shared Channel) transmission.

In the example shown in FIG. 5, the UL transmitting eMBB UE 3 is pre-configured with pre-emptable resources on two 4-symbol mini-slots (durations) in every slot. Specifically, the pre-emptable resources may be assigned to symbols #3-6 (herein referred to as ‘duration 1’) and/or symbols #9-11, 13 (herein referred to as ‘duration 2’) of a given slot (skipping a demodulation reference signal (DMRS) associated with the eMBB UE 3A at symbol #12).

Following UL Pre-emption Indication via UE specific scheduling DCI, the eMBB UE1 suspends transmission on the indicated pre-emptable resource. In this example, the URLLC UE 3B is configured to avoid symbols of the eMBB slot containing control and DMRS, using either duration 1 or duration 2 (or both, if appropriate).

It will be appreciated that an indication of configurable time duration (e.g. a fraction of 1 ms to several milli-seconds) may also be supplied in the UL Pre-emption Indication. If such configurable time duration is indicated with the UL Pre-emption Indication, then there is no need for additional signalling to notify the eMBB UE 3A that it can resume transmission on its configured pre-emptable resources.

The base station 5 may also be configured to use separate power settings to limit a UE's UL transmission (Tx) power for eMBB service over pre-emptable resources. For example, a so-called ‘beta_offset’ (amplitude scaling factor β_{PUSCH} and/or the like) may be defined for the pre-emptable resources in order to enable a different energy per resource element (EPRE) for the pre-emptable resources without changing that of other resources. This can beneficially reduce the potential interference from eMBB transmissions to URLLC UEs on the pre-emptable resources. Such a pre-emptable resource specific power setting is also useful for the case when an initial URLLC transmission occurs before the interfering UE is able to cancel/modify its eMBB transmission.

Preferably, eMBB UEs with good processing capability and UL pre-emption support are selected to schedule over configured URLLC resources. In case that a new MCS/TBS is needed by the eMBB UE for the pre-empted slot, the new MCS/TBS can be signalled by UL Pre-emption Indication or a delta value to update the MCS/TBS implicitly without signalling may be defined.

In summary, pre-emptable resources of eMBB UEs may be configured prior to the arrival of URLLC traffic for URLLC UEs. A mechanism to cancel/modify eMBB transmissions over inter-UE URLLC resources is described. Moreover, a separate power setting may be configured for eMBB UL transmissions over pre-emptable resources to enable a different EPRE (without changing the EPRE of other resources).

UL Pre-emption Indication (second example embodiment) FIG. 6 illustrates another exemplary way in which pre-emption may be realised for supporting URLLC services. In this example, an UL transmitting eMBB UE 3A is configured with pre-emptable resources on a (single) four-symbol mini-slot in every slot. In this example, the pre-emptable resources are assigned to symbols #3-6 of each slot (although in other examples different pre-emptable resources may be used).

Upon receiving an appropriate UL URLLC Pre-emption Indication (in this example, via group common scheduling DCI), the eMBB UE 3A suspends all transmissions on symbols #3-6. It will be appreciated that the associated coding rate may become more than 1 for this UE 3A (due to pre-emption) and the UE 3A may need to wait for retransmission of the PUSCH. In such case, the base station 5 may need to signal new MCS/TBS (Modulation and Coding Scheme/Transport Block Size) to the UE 3A. This may be realised, for example, together with (as part of) the UL Pre-emption Indication.

Alternatively, the MCS/TBS may be updated, for example, by an appropriate delta value without additional signalling. It might also be possible to puncture the pre-empted resources similarly to discontinuous transmission (DTX).

If the eMBB UE 3A is provided with a new/updated MCS/TBS, it needs to perform PUSCH encoding at the new TBS before the first symbol of the eMBB transmission (i.e. the first symbol of the slot in which the pre-emptable resource have been re-assigned to the URLLC UE 3B). Thus, in order to allow the UE 3A to perform appropriate processing for PUSCH encoding, the UL URLLC Pre-emption Indication is transmitted to the eMBB UE 3A such that it has sufficient time to perform such processing at the new MCS/TBS. In the example shown in FIG. 6, the UL URLLC Pre-emption Indication is transmitted at the 8^{th} symbol preceding the start of the slot to which it relates. In other words, the value of the parameter ‘N2’ which defines the delay before the new MCS/TBS is to be applied by the UE 3A is 8.

Similarly to the first example embodiment, since URLLC requires a higher reliability than eMBB, the pre-emption indication for the eMBB UE 3A may have the same (or at least similar) reliability level as URLLC communications.

Beneficially, the eMBB UE 3A is still able to transmit some urgent and dynamically configured UCI type (e.g. HARQ ACK/NACK) without prolonged delay, even at the same time instance/symbols as the pre-empted resources but using a frequency location that is not reserved for URLLC traffic).

In order to reduce the payload size and improve reliability, the eMBB UE 3A may be given a set of pre-configured resources that are pre-emptable. The information on pre-emptable resources can be sent to the eMBB UE 3A either semi-statically via RRC signalling (i.e. in which case RRC configures UE specific ‘time-frequency allocation, offset, periodicity in mini-slot/symbols’, etc. of pre-emptable resources for eMBB) and/or multiplexed with UL grant for the eMBB UE's PUSCH transmission.

Beneficially, a UE specific UL DCI for the eMBB UE 3A may be used to dynamically configure the frequency allocation etc. of pre-emptable resources prior to reception of URLLC traffic (from other UEs). Thus, in this case the UL DCI can be used to override any RRC configuration for the given UE 3A.

Using DL control messaging (such as the ‘UL Pre-emption Indication’ and/or another indication to that effect), the base station 5 activates pre-emption of pre-configured pre-emptible resources previously allocated to the eMBB UE 3A. For example, the base station 5 may configure (via RRC) resource blocks #5 to #7, mini-slots #0 and #1 as pre-emptable resource for a particular eMBB UE (or group of UEs). In this case, “Pre-emption Resource Index=1” may be used to refer to mini-slots #0 (duration 1), “Pre-emption Resource Index=2” may be used to refer to mini-slots #1 (duration 2), and “Pre-emption Resource Index=3” may be used to refer to mini-slots #0 and #1 (both duration 1 and duration 2). Upon receiving the UL Pre-emption Indication, the eMBB UE 3A is configured to stop (or suspend) transmission on the corresponding part of the indicated resources.

This approach has the advantage of having a low control overhead and good spectrum efficiency compared to an approach in which the eMBB service is rescheduled by the base station 5, which typically requires multiple mini-slot based control signalling between the base station 5 and the UE 3A and which can cause a high control signalling overhead. Moreover, the above described approach may beneficially reduce disruption to the eMBB service.

Further Details on UL Pre-Emption Indication

It will be appreciated that the UL URLLC Pre-emption Indication may have the following fields (at least one field):

Field 1: A one-bit or two-bit indication containing an index of the (UE specific) pre-emptable resource.

Field 2: A two-bit indication (optionally present, configurable length via RRC) for configuring a time duration for the pre-emption (e.g. as a fraction of 1 ms to several milli-seconds).

For example, if the indication of pre-emptable resource is ‘1’, the eMBB UE 3A may be configured to pre-empt the UL transmission on the (corresponding) configured pre-emptable resource. If the indication of pre-emptable resource is ‘0’, the eMBB UE 3A may be configured to suspend its UL transmission on all PRBs for the specified duration.

If ‘Field 2’ is present, but the configurable time duration has the value of ‘0’, the UE simply cancels the UL transmission when it receives the UL URLLC Pre-emption Indication. In this case a new UL grant may be used to resume the eMBB transmission. If the configured time duration equals 0.5 eMBB slot, only mini-slots #0 (duration 1) is pre-empted. If the configured time duration equals 2 eMBB slot, both mini-slots #0 (duration 1) and mni-slots #1 (duration 2) can be pre-empted for 2 eMBB slots. It will be appreciated that other pre-empting duration may be configured in an analogous manner.

By indicating a duration associated with the UL URLLC Pre-emption Indication, it is possible to avoid the need for any additional signalling to notify the UE 3A that it can resume (eMBB) transmission on the pre-empted resources (i.e. after the indicated time duration has passed). This beneficially reduces the use of CORSET (control resource set) and the number of DL control monitoring occasions at the UE 3A.

It will be appreciated that the pre-empted area of time/frequency resources of the eMBB UE 3A may be greater than or equal to that of the dynamically scheduled URLLC UE 3B. It may also cover an area of configured grant free URLLC resources of other UEs, if appropriate.

Inter-Cell Interference Avoidance for URLLC

It will be appreciated that the above described multiplexing of eMBB and URLLC traffic is likely to be cell-specific. However, eMBB transmissions by cell-edge high-power UEs' may also cause UL interference or cross-link inter-UE interference to their neighbouring cell's URLLC service. The following is a description of an exemplary mechanism for reducing inter-cell interference for URLLC services.

Neighbouring base stations 5 may be able to co-ordinate the configuration of respective pre-emptable eMBB resources for their cell edge UEs, for example, by exchanging information on fine grain time/frequency allocation and periodicity (SCS, slots, mini-slots etc.) of pre-emptable eMBB resources. For example, information identifying a time domain resource allocation may be exchanged using 2 bits and information identifying a frequency domain resource allocation may be exchanged using 5 bits. Further information identifying an offset, a periodicity in mini-slot/symbols, etc. of URLLC UEs may also be exchanged between neighbouring base stations. Other information that may be sent includes, for example, traffic priority of the URLLC (interfered) UE.

The cells (i.e. base stations) may also be configured to identify and maintain lists of cell edge UEs with high inter-UE interference, e.g. based on inter-UE reference signal (RS) measurements and/or the like. At least eMBB UEs at the cell edge may be configured by their serving base station to perform (using e.g. SRS-RSRP) inter-cell co-ordinated UL inter-UE interference measurements on pre-emptable resources that might be used by URLLC UEs and the results may be exchanged between the base stations over the X2 interface.

The base stations may be configured to update the lists of cell edge UEs with high UL inter-UE interference or cross-link inter UE interference based on the measurement results, and avoid multiplexing transmissions by UEs within the interfering group.

The base stations may also be configured to inform their neighbours when a high (e.g. higher than a predetermined threshold) UL inter-UE interference is detected at URLLC transmission. The base stations may do so by transmitting an X2 UL High Interference Indication (HII) (or similar) including an appropriate flag indicating the presence of inter-UE interference affecting URLLC transmissions.

Thus, when a pre-emption request or an indication of high interference is received for a high priority URLLC service from a neighbouring cell, the serving cell (base station) may be configured to activate pre-emption of eMBB service over the indicated/(pre-) configured time/frequency domain resource(s), for a specified time duration and/or periodicity.

### MODIFICATIONS AND ALTERNATIVES

Detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

It will be appreciated that the above example embodiments may be applied to both 5G New Radio and LTE systems (E-UTRAN).

In the above description, the UE, the access network node (base station), and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that when control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above exemplary embodiments. It will be appreciated that pre-emption may be handled by the user-plane part of the base station without involving the control-plane part (or vice versa).

The above example embodiments are also applicable to ‘non-mobile’ or generally stationary user equipment. The above described mobile device may comprise an MTC/IoT device and/or the like.

The control data may include information identifying a duration (e.g. a fraction of 1 ms to several milli-seconds) for pre-empting said at least one communication resource; and the pre-empting may comprise pre-empting the indicated at least one communication resource for the duration identified by the received control data.

The information identifying at least one communication resource may include information identifying a plurality of sets of at least one communication resource; the control data may include information identifying at least one of said plurality of sets of at least one communication resource; and the pre-empting may comprise pre-empting the identified set or sets of at least one communication resource.

The receiving, by the UE, said information may comprise receiving at least one of: a Radio Resource Control (RRC) message comprising said information identifying said at least one communication resource (e.g. a UE specific time-frequency allocation, an offset, a periodicity, and/or the like); and control information (e.g. an uplink DCI) comprising said information identifying said at least one communication resource.

The pre-empting may comprise pre-empting the indicated at least one communication resource for grant-free URLLC communications.

The control data may comprise at least one of: a field (e.g. one bit or two bits) identifying an index associated with the at least one communication resource to be pre-empted; and a field (e.g. two bits) identifying a duration for pre-empting the at least one communication resource.

The method performed by the UE may further comprise obtaining information identifying a Modulation and Coding Scheme/Transport Block Size (MCS/TBS). The information identifying the MCS/TBS may be included in, or received together with, said control data indicating that at least a part of said at least one communication resource is to be pre-empted for URLLC communications. The information identifying the MCS/TBS may comprise a delta value for updating an MCS/TBS applied by the UE prior to receipt of said control data indicating that at least a part of said at least one communication resource is to be pre-empted for URLLC communications.

The method performed by the UE may further comprise receiving further control data (e.g. a ‘beta offset’, amplitude scaling factor, and/or the like) identifying a transmission (Tx) power level (e.g. energy per resource element, EPRE) associated with the at least one pre-emptable communication resource. The pre-empting may comprise applying the identified Tx power level for transmissions, by the UE, over the indicated at least one communication resource.

The method performed by the network apparatus may further comprise receiving URLLC data over the at least one communication resource indicated by the transmitted control data, wherein the URLLC data is multiplexed with further data, from the UE, over the set of communication resources allocated to the UE.

The method performed by the network apparatus may further comprise allocating at least a part of said at least one communication resource to a different UE for transmitting URLLC data (e.g. in response to a scheduling request from said different UE).

The configuration for URLLC communications may include a configuration for at least one pre-emptable communication resource (e.g. a time/frequency allocation, periodicity, and/or the like).

The method performed by the network apparatus may further comprise receiving, from the neighbouring network apparatus, an indication of high interference; and transmitting, to at least one user equipment (UE), control data indicating that at least one communication resource is to be pre-empted for URLLC communications.

The method performed by the network apparatus may further comprise determining that a UE served by the network apparatus is suffering from a high (e.g. higher than a predetermined threshold) uplink inter-UE interference at URLLC transmission by the UE; and transmitting, to a neighbour base station, an indication (e.g. a X2 UL High Interference Indication (HII) or similar) indicating the presence of inter-UE interference affecting URLLC transmissions.

The method performed by the network apparatus may further comprise maintaining information identifying at least one UE (e.g. a list of one or more UEs) located at or near an edge of a cell of the network apparatus, the at least one UE suffering from a relatively high interference.

The method performed by the network apparatus may further comprise determining whether a particular UE has high interference based on inter-UE reference signal (RS) measurements.

The method performed by the network apparatus may further comprise obtaining, from at least one UE, results of inter-cell co-ordinated uplink inter-UE interference measurements (using e.g. SRS-RSRP); and exchanging said results with a neighbouring base station.

Various other modifications will be apparent to those skilled in the art and will not be described in further detail here.

This application is based upon and claims the benefit of priority from United Kingdom Patent Application No. 1813132.6, filed on Aug. 10, 2018, the disclosure of which is incorporated herein in its entirety by reference.

What is claimed is:

1-25. (canceled)

26. A method performed by a user equipment (UE), the method comprising:
receiving, from a base station, a radio resource control (RRC) message that includes information representing at least one communication resource;
receiving, from the base station, downlink control information (DCI) that includes a first field and a second field; and
cancelling a physical uplink shared channel (PUSCH) transmission based on the information representing the at least one communication resource, the first field related to a frequency of the PUSCH transmission, and the second field related to a time of the PUSCH transmission.

27. The method according to claim 26, wherein the PUSCH transmission is cancelled if a part of the at least one communication resource has a bit value of in the first field and the second field which are included in the DCI.

28. A method performed by a base station, the method comprising:
transmitting, to a user equipment (UE), a radio resource control (RRC) message that includes information representing at least one communication resource; and
transmitting, to the UE, downlink control information (DCI) that includes a first field and a second field;
wherein the information representing the at least one communication resource, the first field related to a frequency of a physical uplink shared channel (PUSCH) transmission, and the second field related to a time of the PUSCH transmission are used to cancel the PUSCH.

29. The method according to claim 28, wherein the PUSCH transmission is cancelled if a part of the at least one communication resource has a bit value of ‘1’ in the first field and the second field which are included in the DCI.

30. A user equipment (UE) comprising:
a transceiver circuit configured:
to receive, from a base station, a radio resource control (RRC) message that includes information representing at least one communication resource; and
to receive, from the base station, downlink control information (DCI) that includes a first field and a second field; and
a controller configured to cancel a physical uplink shared channel (PUSCH) transmission based on the information representing the at least one communication resource, the first field related to a frequency of the PUSCH transmission, and the second field related to a time of the PUSCH transmission.

31. The user equipment according to claim 30, wherein the PUSCH transmission is cancelled if a part of the at least one communication resource has a bit value of ‘1’ in the first field and the second field which are included in the DCI.

32. A base station comprising:
a transceiver circuit configured:
to transmit, to a user equipment (UE), a radio resource control (RRC) message that includes information representing at least one communication resource; and
to transmit, to the UE, downlink control information (DCI) that includes a first field and a second field; wherein the information representing the at least one communication resource, the first field related to a frequency of a physical uplink shared channel (PUSCH) transmission, and the second field related to a time of the PUSCH transmission are used to cancel the PUSCH.

33. The base station according to claim 32, wherein the PUSCH transmission is cancelled if a part of the at least one communication resource has a bit value of ‘1’ in the first field and the second field which are included in the DCI.
